(19) United States
(12) Patent Application Publication
(10) Pub. No.: US 2004/0164705 A1
(43) Pub. Date: Aug. 26, 2004

(54) Onboard power supply system

(75) Inventor: Makoto Taniguchi, Kariya-city (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/777,098

(22) Filed: Feb. 13, 2004

(30) Foreign Application Priority Data
Feb. 25, 2003 (JP) 2003-047632

(51) Int. Cl. H02J 7/14

(52) U.S. Cl. 320/104

(57) ABSTRACT

An onboard power supply system includes a power generator, a main battery, a sub-battery, and a control device. The main battery is charged by the power generator. The control device controls charge and discharge of the sub-battery according to at least one of a state of charge of the main battery and a state of power generation of the power generator.

### CROSS REFERENCE TO RELATED APPLICATION

This application is based on and incorporates herein by reference Japanese Patent Application No. 2003-47632 filed on Feb. 25, 2003.

### FIELD OF THE INVENTION

The present invention relates to an onboard power supply system having multiple electrical power storage devices.

### BACKGROUND OF THE INVENTION

Various kinds of devices installed in a vehicle are electrically operated and become sophisticated. As a result, demand for improvement in capacity and reliability of an onboard power supply increases. Some systems to respond such demand have been introduced. For example, onboard power supply systems having multiple electrical power storage devices to provide dual power supply are proposed in JP-A-2000-308275, JP-A-2001-69683, and JP-A-63-56135. In these systems, the first electrical power storage devices are charged by the power generator and others are charged by the first power storage device.

Furthermore, a method for controlling power generation of a power generator according to operating conditions of a vehicle for charging an electrical power storage device is proposed in JP-A-6-189600. The fuel consumption can be reduced by this method. In this method, the power storage device is charged regardless of states of charge in the power storage device. Therefore, when this method is applied to the power supply system having multiple electrical power storage devices, output voltages of the first power storage device will greatly vary. This may cause frequent reduction in terminal voltage of the first power storage device and frequent discharge of the other power storage devices.

The frequent discharge of the other power devices is not desirable in the case that they are used as an emergency power supply. However, the charge and discharge control for charging the auxiliary power storage devices in case of emergency. If the frequent discharge occurs during normal operations of the vehicle, the other power devices may not be able to provide stable power supply in an emergency.

### SUMMARY OF THE INVENTION

The present invention therefore has an objective to provide an onboard power supply system that provides stable emergency power supply. An onboard power supply system of the present invention includes a power generator, a first electrical power storage device, a second electrical power storage device, and a charge and discharge control device. The first storage device is charged by the power generator. The control device controls charge and discharge of the second storage device based on at least one of a first quantity and a second quantity. The first quantity indicates a state of charge in the first power storage device and a second quantity indicates a state of power generation in the power generator. With this configuration, the second storage device does not automatically discharge according to the first and the second quantities. Thus, the second storage device can provide stable power supply.

The charge and discharge control device controls the discharge of the second storage device when the first quantity is equal to or smaller than a predetermined value. This disables the discharge of the second storage device when the first storage device is not in a good state of charge. Therefore, the second storage device can provide stable emergency power supply.

### BRIEF DESCRIPTION OF THE DRAWINGS

The above and other objectives, features and advantages of the present invention will become more apparent from the following detailed description made with reference to the accompanying drawings. In the drawings:

FIG. 1 is a block diagram of an onboard power supply system according to the first embodiment of the present invention;

FIG. 2 is a flowchart of control operation performed by a control device according to the first embodiment;

FIG. 3 is a block diagram of an onboard power supply system according to the second embodiment of the present invention; and

FIG. 4 is a block diagram of an onboard power supply system according to the third embodiment of the present invention.

### DETAILED DESCRIPTION OF THE PREFERRED EMBODIMENT

The preferred embodiments of the present invention will be explained with reference to the accompanying drawings. In the drawings, the same numerals are used for the same components and devices.

### First Embodiment

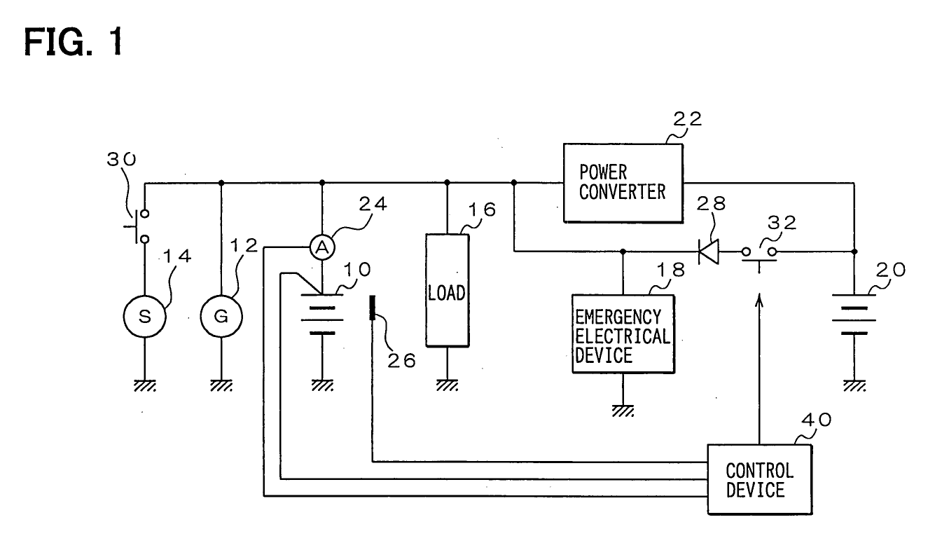

Referring to FIG. 1, an onboard power supply system includes a main battery 10, a power generator (G) 12, a starter (S) 14, an electrical load 16, an emergency electrical device 18, a sub-battery 20, a power converter 22, a current sensor 24, a temperature sensor 26, a diode 28, switches 30, 32, and a control device 40. The main battery, the sub-battery, and the control device 40 corresponds to the first power storage device, the second power storage device, and the charge and discharge control device, respectively.

The power generator 12 is driven by an engine (not shown) and generates power for charging the main battery 10 and for operating the electrical load. The starter 14 starts the engine by rotating a crank shaft of the engine. The electrical load 16 is an electrical device, such as a light and an air conditioner, used during a normal driving condition. The emergency electrical device 18 is an electrical device used in an emergency condition and remains in a standby condition during the normal driving condition.

The sub-battery 20 is an auxiliary battery for supplying power to the emergency electrical device 18 when the power supply from the main battery 10 to the device 18 is not normal. The power converter 22 converts a variable voltage applied by the main battery 10 to a substantially constant voltage. The substantially constant voltage is applied to a terminal of the sub-battery 20 for charge.

The current sensor 24 detects charge current and discharge current at a terminal of the main battery 10. The temperature sensor 26 is arranged at a predetermined position of the main battery 10 for detecting temperatures of the main battery 10. The diode 28 is interposed in an electrical line that connects the sub-battery 20 with the emergency electrical device 18. The diode 28 interrupts a current flow from the main battery 10 to the sub-battery 20 via the electrical line of the emergency electrical device 18. The switch 30 is an ignition switch that interlocks with an ignition key. Power is supplied to the starter 14 when it is closed. The switch 32 is connected in series with the diode 28. Power is supplied from the sub-battery 20 to the emergency electrical device 18 when it is closed.

The control device 40 controls the state of discharge of the sub-battery 20 by opening and closing the switch 32. The control device 40 performs this control based on a terminal voltage, the state of charge, and the temperature of the battery 10. The terminal voltage is directly detected, the state of charge is determined based on the charge and discharge current detected by the current sensor 24, and the temperature is detected by the temperature sensor 26.

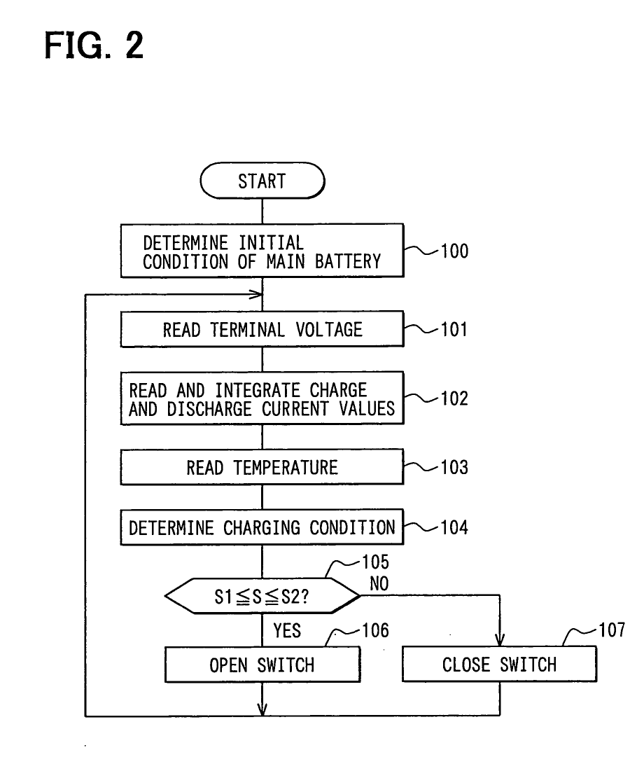

The control device 40 performs the control operation of charge and discharge of the sub-battery 20 as shown in FIG. 2. When a key switch (not shown) is turned on, the control device 40 determines an initial state quantity S0 that indicates an initial state of charge of the main battery 10 (S100). The initial state quantity SO can be determined with different kinds of method. For example, a quantity that indicates a state of charge measured at the last time when the key switch is turned off is stored, and it is read out when the key switch is turned on and set as an initial state quantity SO. Alternatively, variations in terminal voltage of the main battery 10 are monitored and a quantity that indicates a state of charge is detected at the time when the key switch is turned on. The variations occur when a predetermined current discharge is performed.

The control device 40 reads the terminal voltage of the main battery by reading a voltage appears at a detection line that is led out of the terminal of the main battery (S101). The control device 40 reads charge and discharge current values of the main battery 10 by reading outputs of the current sensor 24 and integrate the read current values (S102). The control device 40 reads a temperature of the main battery 10 by reading an output of the temperature sensor 26 (S103). The steps for reading the terminal voltage, the charge and discharge current, and the temperature can be performed in any order, and the order can be changed as necessary.

The control device 40 determines a current state quantity S that indicates the current state of charge of the main battery 10 (S104). It determines the current state quantity S based on the initial state quantity S0 and the readings of the terminal voltage, the current, and the temperature (S104). The current state quantity S can be calculated based on the initial state quantity S0 and the charge and discharge current values integrated at step S102. In this embodiment, however, the current state quantity S is determined based on the further consideration of the temperature and the terminal voltage. Existing methods can be used for determining the state quantities that indicates the states of charge.

The control device 40 determines whether the current state quantity S is within a predetermined range, namely, equal to or higher than a lower limit value S1 and equal to or lower than an upper limit value S2 (S105). If the current state quantity S is within the predetermined range, the control device 40 opens the switch 32 (S106). This disables power supply from the sub-battery 20 to the emergency electrical device 18. If the current state quantity S is out of the predetermined range, the control device 40 closes the switch 32 (S107). This enables the power supply from the sub-battery 20 to the emergency electrical device 18.

The sub-battery 20 is provided for supplying power to the emergency electrical device 18 when the state of charge of the main battery 10 is lower than a certain level. If the main battery 10 is not in a good state of charge, namely, the state quantity S is lower than the lower limit S1 (first state), the switch 32 is immediately closed. As a result, the sub-battery 20 becomes ready for supplying power to the emergency electrical device 18.

If the main battery 10 is in a good state of charge, namely, the state quantity S is higher than the higher limit S2 (second state), the terminal voltage of the main battery 10 is higher than the terminal voltage of the sub-battery 20. This is when the main battery 10 and the sub-battery 20 are rated at the same volts. Power is supplied mainly from the main battery 20 to the emergency electrical device 18 even when the switch 32 is closed in the circuit shown in FIG. 1. Therefore the closing of the switch 32 is meaningless.

Furthermore, the power may be supplied from the sub-battery 20 to the emergency electrical device 18 if the switch 32 is closed in the condition that the main battery 10 is in the better state than the first state and worse than the second state. Since the sub-battery is provided for the emergency purpose, the sub-battery 20 is required to be consistently in a good state of charge. Therefore, the discharge of the sub-battery 20 has to be reduced to the minimum when the main battery 10 is in a better state of charge than the first state. In this embodiment, the switch 32 is closed only when the main battery 10 is in the better state than the first state and in the worse state than the second state (YES at step S105).

The sub-battery 20 is not automatically charged according to the state quantities that indicate states of charge of the main battery 10. Therefore, the sub-battery 20 can provide stable power supply in an emergency. The discharge of the sub-battery 20 is reduced when the current state quantity S of the main battery 10 is equal to or lower than the upper limit S2. Namely, the discharge of the sub-battery 20 is reduced when the main battery 10 is not in a good state of charge. Thus, the sub-battery 20 can provide stable power supply in an emergency.

Power is supply to the emergency electrical device 18 from at least one of the main battery 10 and the sub-battery 20, mainly from the main battery 10. The sub-battery 20 is capable of supplying the power to the emergency electrical device 18 whenever required. As a result, the power is properly supply to the emergency electrical device 18. The sub-battery 20 is connected to the main battery 10 instead of the power generator 12 for charge. The sub-battery is charged when the state of charge of the main battery 10 is good and the state of charge of the sub-battery is maintained in good condition even when the state of charge of the main battery becomes poor. Therefore, the sub-battery 20 can stably provide power supply.

### Second Embodiment

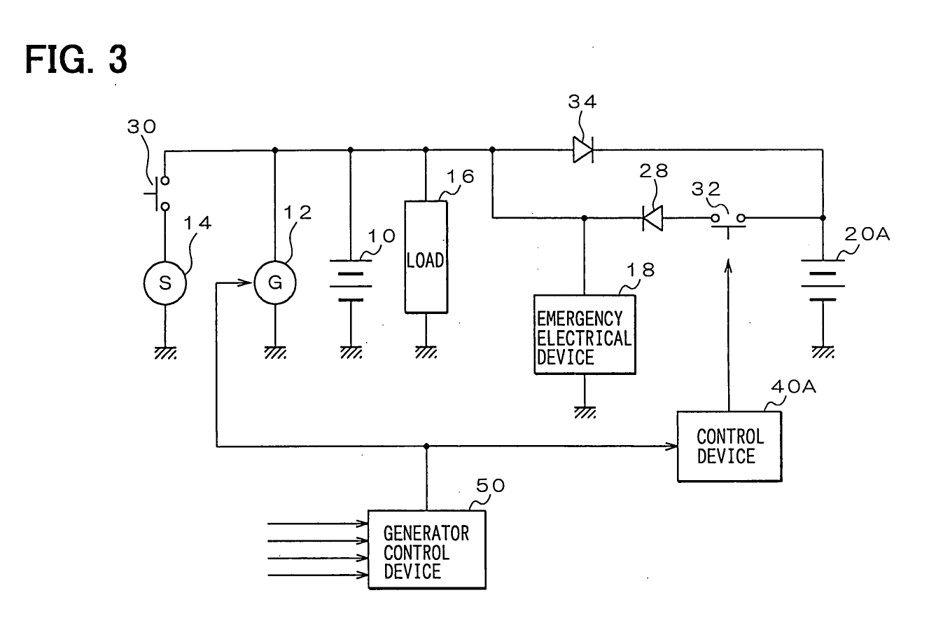

Referring to FIG. 3, an onboard power supply system includes the main battery 10, the generator (G) 12, the starter (S) 14, the electrical load 16, the emergency electrical device 18, a sub-battery 20A, the diode 28, another diode 34, the switches 30, 32, a control device 40A, and a power generator control device 50. In comparison with the first embodiment, the power converter 22 is replaced with the diode 34, the current sensor 12 and the temperature sensor 26 are removed, and the power generator control device 50 is added.

The sub-battery 20A is an auxiliary battery that provides power supply to the emergency electrical device 18 when power supply from the main battery 10 is not normal. Batteries with the same rated voltage are used for the main battery 10 and the sub-battery 20A. The diode 34 controls a current flow between the main battery 10 and the sub-battery 20A. It allows the current flow from the main battery 10 to the sub-battery 20A, and interrupts the current from the sub-battery 20A to the main battery 10.

The power generator control device 50 sets a target value for power generation of the power generator 12 according to state quantities of the vehicle. The target value, such as a target voltage, corresponds to a state quantity that indicates a state of power generation of the power generator 12. The power generator control device 50 outputs an instruction signal indicating the target value. For example, when the vehicle is under accelerating conditions, the generator control device 50 sets the target voltage lower than normal for reducing the power generation and the torque. When the vehicle is under decelerating conditions, the generator control device 50 sets the target voltage higher than normal for increasing the power generation to regenerate a part of decelerating energy into electrical energy. An instruction signal indicating the target voltage is sent to the power generator 12 and the control device 40A.

The control device 40A opens the switch 32 when the target voltage is set lower than normal, namely, a signal indicating the lower-than-normal target voltage is outputted. This disables the discharge of the sub-battery 20A. When the target voltage is set lower than normal, a terminal voltage of the main battery 10 is lowered. Therefore, power is supplied to the emergency electrical device 18 from the sub-battery 20A if the switch 32 is closed. A voltage drop at the terminal occurs under normal conditions when the power generation of the power generator 12 is intentionally performed. Under such conditions, the switch 32 is open for reducing the discharge of the sub-battery 20A. If the voltage drop occurs during the power generation, the charging capacity of the main battery 10 is reduced. Thus, the switch 32 is closed to enable the discharge of the sub-battery 20A for proper operation of the emergency electrical device 18.

In this system, the sub-battery 20A is not automatically discharged according to the state quantity of power generation. As a result, the sub-battery 20A can provide stable power supply in an emergency.

The terminal voltage of the main battery 10 may greatly vary when the power generation of the power generator 12 is controlled according to the conditions of the vehicle for reducing fuel consumption. In this case, the discharge of the sub-battery 20A is enabled when the main battery 10 is not in the good state of charge. As a result, the sub-battery may not be able to supply power to the emergency electrical device 18 in an emergency. Since the power supply system controls the discharge of the sub-battery 20A when the main battery 10 is not in the good state of charge, the sub-battery 20A is maintained in the good state of charge. Thus, the sub-battery 20A can provide stable power supply while the fuel consumption is reduced.

The power generation is controlled by the generator control device 50 when the vehicle is under accelerating conditions. The discharge of the sub-battery 20A is disabled when the terminal voltage of the main battery 10 is reduced by the power generation control, which is normally performed under accelerating conditions. Therefore, the sub-battery 20A can provide stable power supply.

The discharge of the sub-battery 20A is controlled by the control device 40A when the power generation is controlled by the generator control device 50. Namely, the control signal for the power generation control can be used as a trigger for the discharge control of the sub-battery 20A. Therefore, a special sensor or algorithm is not required for triggering the discharge control. This allows a simplification of the system configuration and easy addition of a discharge control function to the system.

Since batteries with the same rated voltage are used for the main battery 10 and the sub-battery 20A, a device for supplying power to the emergency electrical device 18, such as the power converter 22, is not required. This allows a simplification of the system configuration.

### Third Embodiment

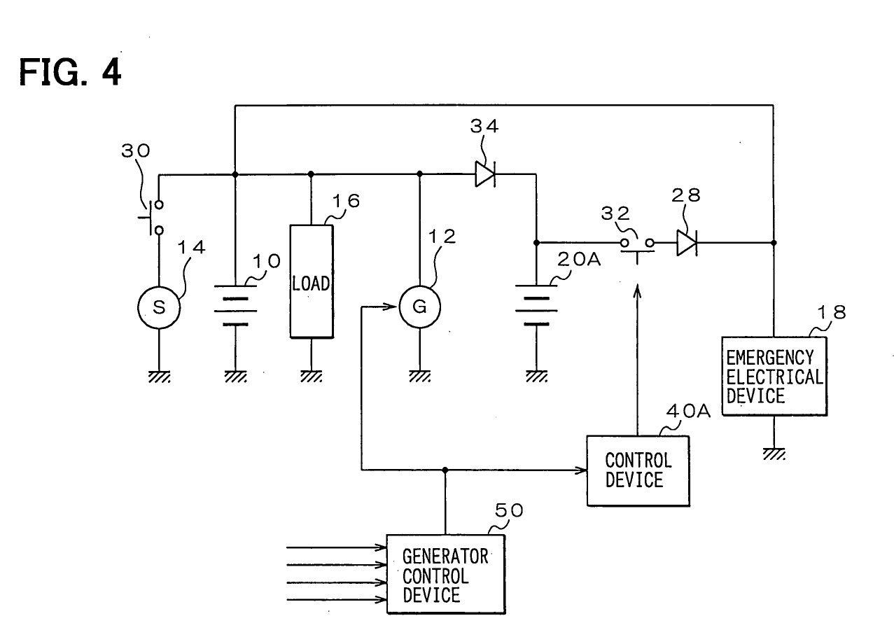

Referring to FIG. 4, an onboard power supply system includes the main battery 10, the power generator (G) 12, the starter (S) 14, the electrical load 16, the emergency electrical device 18, the sub-battery 20A, diodes 28, 34, the switches 30, 32, a control device 40A, and the power generator control device 50. The same components and devices used in the second embodiment will not be discussed here.

In this system, the sub-battery 20A is connected to an output terminal of the power generator 12 via the diode 34. Power is directly supplied to the emergency electrical device 18 by the main battery 10. When the switch 32 is closed, the power is supplied to the emergency electrical device 18 by the sub-battery 20A via the diode 28 along with the main battery 10. With this configuration, the sub-battery 20A is directly charged by the power generator 12 during the power generation. As a result, the sub-battery 20A is maintained in even better state of charge.

The present invention should not be limited to the embodiment previously discussed and shown in the figures, but may be implemented in various ways without departing from the spirit of the invention. For example, the main battery 10 and the sub-battery 20A may be installed in an engine compartment and a trunk compartment, respectively, although the installation locations are not specified above. When the main battery 10 is installed in the engine compartment, the terminal voltage will greatly vary due to large temperature variations. The sub-battery 20, 20A is, however, maintained in the good state of charge. Variations in the terminal voltage of the sub-battery 20, 20A are reduced by placing it in the trunk compartment. Thus, the sub-battery 20, 20A is maintained in the good state of charge and the stability of the power supply of the sub-battery 20, 20A improves.

The charge and discharge control of the sub-battery 20 can be performed according to a combination of the state of charge of the main battery 10 and the power generating state of the power generator 12. The control device 40, 40A may control the switch 30 so that it is open for a predetermined period after the start of the starter 14, which is indicated by an ignition signal outputted when the switch 30 is closed. Namely, the discharge of the sub-battery 20, 20A is disabled during a period that the main battery 10 is not in the good state of charge upon the startup and the emergency electronic device 18 is not required to be operated. A large amount of power is supplied to the starter 14 upon the startup of the engine and the state of charge of the main battery 10 becomes worse. When the sub-battery 20, 20A is discharged in this condition, the amount of discharge will be large. Therefore, it is preferable to disable the discharge of the sub-battery 20, 20A during the operation of the starter 14 for maintaining the sub-battery 20, 20A in the good state of charge.

What is claimed is:

1. An onboard power supply system comprising:
a power generator;
a first electrical power storage device charged by the power generator;
a second electrical power storage device; and
a charge and discharge control device for controlling charge and discharge of the second electrical power storage device based on at least one of a first state quantity that indicates a state of charge of the first power storage device and a second state quantity that indicates a state of power generation of the power generator.

2. The onboard power supply system according to claim 1, wherein the charge and discharge control device controls the charge and discharge of the second electrical power storage device when the first state quantity is equal to or smaller than a predetermined value.

3. The onboard power supply system according to claim 1, further comprising a power generation control device, wherein the power generation control device is connected with the power generator for controlling the state of power generation of the power generator according to operating conditions of a vehicle.

4. The onboard power supply system according to claim 3, wherein the power generation control device reduces the power generation of the power generator when the vehicle is in an accelerating condition.

5. The onboard power supply system according to claim 3, wherein the charge and discharge control device reduces the discharge of the second electrical power storage device when the power generation of the power generator is reduced by the power generation control device.

6. The onboard power supply system according to claim 1, wherein the discharge of the second electrical power storage device is disabled during a startup of an engine.

7. The onboard power supply system according to claim 1, further comprising an electrical device that is provided with power by at least one of the first electrical power storage device and the second electrical power storage device, wherein:
the first electrical power storage device functions as a main power supply;
the second electrical power storage device functions as an auxiliary power supply; and
the second electrical power storage devices is capable of supplying the power to the electrical device whenever required.

8. The onboard power supply system according to claim 1, further comprising an electrical device, wherein:
the first electrical power storage device functions as a main power supply;
the second electrical power storage device functions as an auxiliary power supply; and
the second electrical power storage device supplies power to the electrical device along with the first electrical power storage device.

9. The onboard power supply system according to claim 8, wherein the second electrical power storage device supplies power along with the first electrical power storage device during the power generation of the power generator.

10. The onboard power supply system according to claim 8, wherein the second electrical power storage device is directly charged by the power generator during the power generation of the power generator.

11. The onboard power supply system according to claim 1, wherein:
the first electrical power storage device is installed in an engine compartment of the vehicle; and
the second electrical power storage device is installed in any one of an interior compartment and a trunk compartment of the vehicle.

12. The onboard power supply system according to claim 1, wherein the first electrical power storage device and the second electrical power storage device are rated at same volts.

13. The onboard power supply system according to claim 1, wherein the second electrical power storage device is charged by the first electrical power storage device.
